(19) United States
(12) Patent Application Publication
(10) Pub. No.: US 2016/0262966 A1
(43) Pub. Date: Sep. 15, 2016

(54) Bathing Assistance Apparatus

(71) Applicant: Elizabeth Paczkowski, Tewksbury, MA (US)

(72) Inventor: Elizabeth Paczkowski, Tewksbury, MA (US)

(21) Appl. No.: 15/069,812

(22) Filed: Mar. 14, 2016

Related U.S. Application Data
(60) Provisional application No. 62/132,453, filed on Mar. 12, 2015.

(51) Int. Cl. A61G 7/10; A47K 3/12

(52) U.S. Cl. CPC A61G 7/1003; A61G 7/1021; A47K 3/122; A61G 2200/34; A61G 2203/12

(57) ABSTRACT

A bathing assistance apparatus for assisting a user getting into and out of a bath tub is provided. The bathing assistance apparatus comprises a seat assembly having an inflatable seat portion and a back rest portion. The back rest portion extends in a generally upward direction from the seat portion. An air pump is pneumatically connected to the seat portion of the seat assembly. The seat portion of the seat assembly is selectively inflatable and deflatable to raise and lower a user within the bath tub.

### CLAIM OF PRIORITY

This patent application claims priority under 35 USC 119 (e) (1) from U.S. Provisional Patent Application Ser. No. 62/132,453 filed Mar. 12, 2015, of common inventorship herewith entitled, “The Pneumatic Bath Assist,” which is incorporated herein by reference as though the same were set forth in its entirety.

### FIELD OF THE INVENTION

The present invention pertains to the field of assistive seating, and more specifically to the field of bathtub and water seats.

### BACKGROUND OF THE INVENTION

With today's heightened awareness of health concerns and constantly improving medical care, people are living longer than previous generations. As the baby boomer generation gets older, dramatic increases are expected in the elderly population. If the unprecedented increase in life expectancy has a downside, it is exposure of risk to chronic aging disorders. Such serious ailments as diabetes, Alzheimer's and Parkinson's diseases are but a few of the disabling disorders that keep many older persons from enjoying their longevity. Elderly individuals also have to deal with physical infirmities brought on by the inevitability of aging. A significant number of people over the age of sixty five have osteoarthritis and approximately one half of those people are seriously disabled by it.

Challenges presented to those with limited mobility are not exclusive to the elderly. Numerous middle age and younger people suffer from some form of disability that hinders independent movement. Numerous individuals have temporary ailments such as broken bones or postoperative conditions.

As many people with limited mobility can easily attest, attempting to complete day to day tasks without assistance is daunting and frustrating. Many who suffer various forms of limited mobility such as arthritis, back pain or stiff joints often find it very difficult, sometimes impossible, to lower themselves to or rise from a seated position without experiencing extreme pain. These mobility challenges contain a high degree of risk. Individuals without caregivers to lend a hand or without the proper equipment to support movement can injure themselves in spills and falls, possibly fracturing bones or even breaking their hip. A specific challenge and risk relates to entering or exiting one's bath tub. The simple act of lowering oneself into or raising oneself up out of a tub is extremely challenging for people with mobility issues. Failing to maintain sure footing when entering or exiting a bathtub can cause a bather to slip and possibly sustain a serious injury.

The prior art has put forth several designs for bathtub and water seats. Among these are:

U.S. Pat. No. 3,740,095 to Walter Phillip Nail describes a lounge of sturdy construction having merit as a safe reliable sea lounge and is characterized by the provision of an inflatable generally flat central platform which is buoyant and substantially rigid when inflated and which is surrounded with a plurality of separate inflatable peripheral compartments rising above the platform when inflated. The arrangement of the peripheral compartments provide a buoyancy distribution that will impart complete stability to the lounge when in use in the water and yet will enable the lounge to be easily mounted by a person in the water. The invention's back and sides support a person on the lounge in a comfortable reclining position with the person's weight properly oriented on the lounge.

U.S. Pat. No. 3,311,930 to Thomas N. Bourke describes a bathtub seat structure which is lightweight, stable, durable and convenient to operate. The bathtub seat structure comprises three substantially rigid boards, one of which rests on the bathtub bottom, another of which has rigid hinged connections to opposite ends of upper and lower boards. A pair of inflatable bags are provided between the sloped interconnecting board and the top and bottom boards. The rigidity of the boards provides stability against lateral tipping and means are provided for restraining the transfer of water between the inflated bags and providing longitudinal stability.

U.S. Pat. No. 2,582,439 to James O. Kavanagh describes a lounging device which has a back rest portion for supporting a bather's back and head and a seat portion hinged thereto. Each portion comprises a plurality of pneumatic cushions formed by inflating a group of elongated sealed envelopes of a suitable pliable material such as plastic. The number and arrangement of the cushions is such that the rigidity of the device and the comfort of the user are at a maximum. The underside of the seat portion is provided with a plurality of vacuum cups which are preferably of the same material as the envelopes and heat sealed to the latter, or they may be sealed to flat edge or side portions of the lounging device. These vacuum cups prevent the seat portion from slipping along the bottom of the tub. The device weighs very little when uninflated, approximately one pound, and is foldable into a small parcel. The device is easily inflatable and may be hung on the back of a closet door when not in use.

None of these prior art references describe the present invention.

### SUMMARY OF THE INVENTION

It is an object of the present invention to provide an assistive lift system comprised of an ergonomic inflatable chair and operational components configured for easy installation in any existing bathtub.

The present invention is a bathing assistance apparatus for assisting a user getting into and out of a bath tub. The bathing assistance apparatus comprises a seat assembly having an inflatable seat portion and a back rest portion. The back rest portion extends in a generally upward direction from the seat portion. An air pump is pneumatically connected to the seat portion of the seat assembly. The seat portion of the seat assembly is selectively inflatable and deflatable to raise and lower a user within the bath tub.

In addition, the present invention includes a method for assisting a user getting into and out of a bath tub. The method comprises providing a seat assembly having an inflatable seat portion and a back rest portion, extending the back rest portion in a generally upward direction from the seat portion, pneumatically connecting an air pump to the seat portion of the seat assembly, inflating the seat assembly thereby raising the seat portion of the seat assembly, and deflating the seat assembly thereby lowering the seat portion of the seat assembly.

The present invention further includes a bathing assistance apparatus for assisting a user getting into and out of a bath tub. The bathing assistance apparatus comprises a seat assembly having an inflatable seat portion and a back rest portion. The back rest portion extends in a generally upward direction from the seat portion. The seat portion has a plurality of inflatable chambers positioned one atop the other. An air pump is pneumatically connected to the seat portion of the seat assembly by an elongated tubing. A least one suction cup is secured to the seat portion of the seat assembly with the suction cup interactable with a surface of the bath tub. The seat portion of the seat assembly is selectively inflatable and deflatable to raise and lower a user within the bath tub.

### BRIEF DESCRIPTION OF THE DRAWINGS

FIG. 1 is a perspective view illustrating a bathing assistance apparatus constructed in accordance with the present invention having an inflatable seat assembly and pneumatically attached air pump with the seat assembly in an inflated condition.

FIG. 2 is another perspective view illustrating the bathing assistance apparatus constructed in accordance with the present invention having the inflatable seat assembly and pneumatically attached air pump with the seat assembly in the inflated position.

FIG. 3 is a perspective view illustrating the bathing assistance apparatus constructed in accordance with the present invention having the inflatable seat assembly and pneumatically attached air pump with the seat assembly in a deflated position.

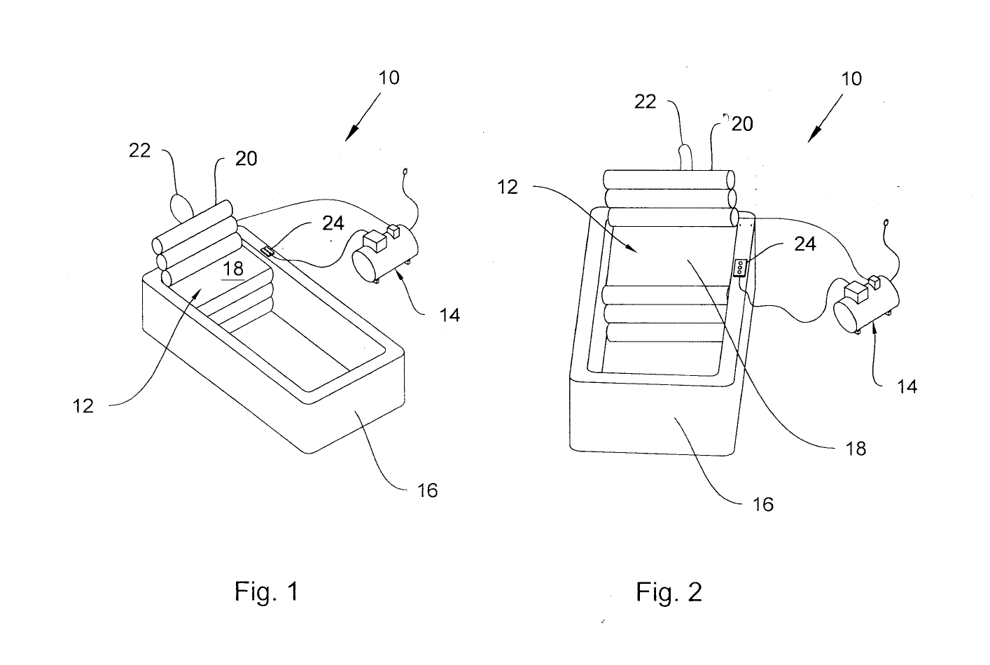

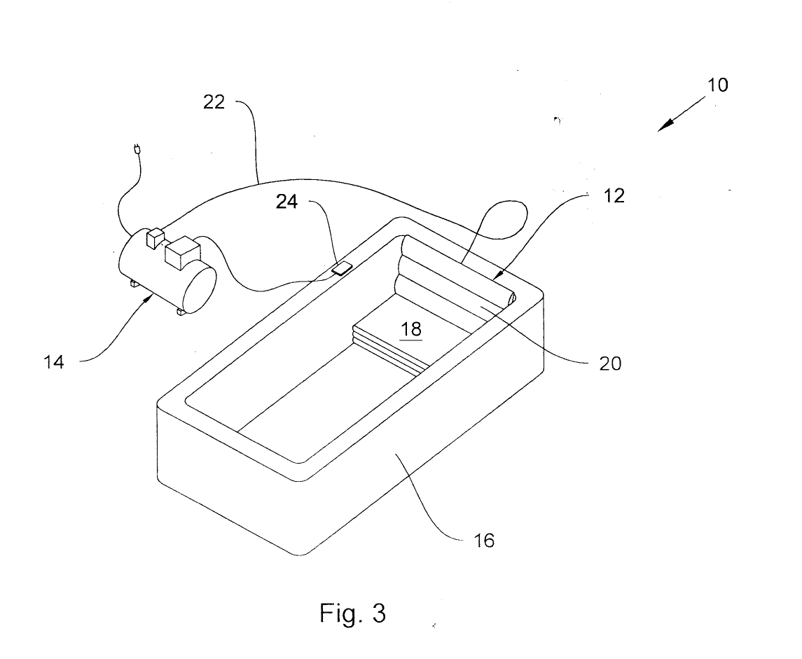

### DETAILED DESCRIPTION OF THE INVENTION

The present invention, hereinafter referred to as the Bathing Assistance Apparatus, indicated generally at 10, is an assistive lift system comprised of an ergonomic inflatable chair or seat assembly 12, a pneumatically attached air pump 14, and operational components configured for easy installation in any existing bath tub 16. The Bathing Assistance Apparatus 10 readily facilitates the act of raising and lowering oneself into the bath tub 16.

As stated, the Bathing Assistance Apparatus 10 of the present invention is comprised of the inflatable seat assembly 12 along with an integrated air pump 14 that enables a user to raise or lower the seat assembly 12 on demand. The inflatable seat assembly 12 includes a seat portion 18 and a back rest portion 20 and is manufactured primarily of a heavy duty and puncture resistant material such as soft rubber, vinyl or comparable waterproof fabric.

In a preferred embodiment, the seat portion 18 of the inflatable seat assembly 12 of the Bathing Assistance Apparatus 10 of the present invention is a rectangular seat portion 18 measuring approximately twenty inches in width and twenty four inches in length.

Preferably, the seat portion 18 comprises three inflatable chambers positioned one atop the other. All or some of the chambers can be inflated depending on the desired height of the seat portion 18 by the user. When all three chambers are fully inflated, the seat portion 18 extends up to approximately seventeen inches in height, enabling the user to easily raise their body out of the tub. When all three chambers are deflated, the seat portion 18 provides several inches of cushiony support, thus providing a soft buffer between the user's body and the hard surface of the bath tub 16.

The back rest portion 20 of the inflatable seat assembly 12 of the Bathing Assistance Apparatus 10 of the present invention is preferably an ergonomic back rest portion 20 attached integrally to a rear edge of the seat portion 18 of the seat assembly 12. Preferably, the back rest portion 20 measures approximately twenty inches in width and twelve inches in height. Constructed similarly to the seat portion 18, the back rest portion 20 comprises three tubular sections positioned one atop the other. The tubular sections of the back rest portion 20 can either be filled with a foam or other soft material or inflated to a desired inflation level by the user to provide the ultimate desired comfort level.

A series of heavy duty suction cups are located on the underside of the seat portion 18 of the seat assembly 12 of the Bathing Assistance Apparatus 10 of the present invention. The suction cups securely affix the seat portion 18 of the seat assembly 12 to the surface of the tub 16 and/or securely affix the back rest portion 20 of the seat assembly 12 to the back wall of the tub 16 to provide structural support. Elongated tubing 22 attached integrally to the top of the back rest portion 20 connects the seat assembly 12 to the motorized air pump 14 placed outside the bathtub 16. The pump 14 can be placed on the floor or on a table or counter top depending on the desires of the user.

Compact in size with waterproof construction, the air pump 14 of the Bathing Assistance Apparatus 10 of the present invention operates on a conventional one hundred ten volt, sixty hertz electrical outlet or a rechargeable battery. The air pump 14 rests on an elevated tray table measuring approximately fifteen inches in height.

The tray table extends approximately two inches more in length and width than the air pump 14 and includes nonskid rubber feet. The air pump 14 and elevated tray table are configured to be placed conveniently next to the bathtub 16. A storage shelf is incorporated into the tray table with the upper support tray containing an integrated drainage port for use in draining water if necessary.

A waterproof remote control 24 is included for use with the Bathing Assistance Apparatus 10. A user utilizes the remote control 24 to activate the air pump 14 and control the height and air distribution within the seat assembly 12. Operational controls also are incorporated in the air pump 14. The Bathing Assistance Apparatus 10 is manufactured in a variety of colors and neutral hues to complement existing bathroom decors.

Use of the Bathing Assistance Apparatus 10 of the present invention is simple and straight forward. A user selects the Bathing Assistance Apparatus 10 in a preferred color and installs it in their bathtub 16. Placing the square shaped seat assembly 12 in the bottom the tub 16, the user positions the Bathing Assistance Apparatus 10 so that the back rest portion 20 of the seat assembly 12 is flush against the tub's back rest. The user or installer then presses firmly on the seat portion 18 of the seat assembly 12 allowing the suction cups to adhere to the tub floor. The installer places the air pump 14 directly beside or near the tub 16 and plugs it into a nearby wall or floor outlet.

Prior to taking a bath, the user utilizes the remote control 24 to inflate the Bathing Assistance Apparatus 10 of the present invention to capacity, raising the seat portion 18 of the seat assembly 12 approximately seventeen inches off the tub floor and enabling the bather to easily slide on the seat assembly 12. Comfortably seated on the Bathing Assistance Apparatus 10, the user then lowers the seat portion 18 of the seat assembly 12 to a desired level, making any necessary adjustments to the air distribution in the seat portion 18 and/or the back rest portion 20 to afford optimal comfort. The user fills the bath with warm water, bath oil or other products as so desired. The user bathes their body as usual, enjoying the soothing and relaxing comfort that a soak in a warm bath provides. Upon finishing the bath, the user drains the tub 16 while remaining on the deflated seat portion 18. When the tub 16 is drained, the user then activates the inflation pump 14 with the remote device 24, thus raising the seat portion 18 of the seat assembly 12 and allowing for a safe exit.

A mechanical lift mechanism incorporated into a cushiony soft inflatable bath seat, the Bathing Assistance Apparatus 10 of the present invention readily assists a user in the arduous task of climbing into or out of their bath. Effectively eliminating the dangerous slipping hazards associated with entering or exiting a tub 16, the Bathing Assistance Apparatus 10 is an invaluable safety tool that protects the health and well-being of users. Primarily configured for home use, the Bathing Assistance Apparatus 10 also functions effectively in hospitals, nursing homes, and rehabilitation centers. Using the Bathing Assistance Apparatus 10 reduces the amount of hot water used when taking a bath. Durably constructed, the Bathing Assistance Apparatus 10 will withstand years of repeated use, with ease.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claim.

1. A bathing assistance apparatus for assisting a user getting into and out of a bath tub, the bathing assistance apparatus comprising:
a seat assembly having an inflatable seat portion and a back rest portion, the back rest portion extending in a generally upward direction from the seat portion; and
an air pump pneumatically connected to the seat portion of the seat assembly;
wherein the seat portion of the seat assembly is selectively inflatable and deflatable to raise and lower a user within the bath tub.

2. The bathing assistance apparatus of claim 1 wherein the seat portion and the back rest portion are constructed from a puncture resistant material selected from the group consisting of rubber, vinyl, and comparable waterproof fabric.

3. The bathing assistance apparatus of claim 1 wherein the seat portion includes a plurality of inflatable chambers positioned one atop the other.

4. The bathing assistance apparatus of claim 3 and further comprising:
three inflatable chambers.

5. The bathing assistance apparatus of claim 3 wherein all chambers are inflatable simultaneously.

6. The bathing assistance apparatus of claim 3 wherein only selected chambers are inflatable individually.

7. The bathing assistance apparatus of claim 1 wherein the back rest portion is an ergonomic back rest.

8. The bathing assistance apparatus of claim 7 wherein the back rest portion includes three tubular sections filled with a foam material.

9. The bathing assistance apparatus of claim 1 wherein back rest is inflatable.

10. The bathing assistance apparatus of claim 9 wherein the back rest portion of the seat assembly is pneumatically connected to the seat portion of the seat assembly.

11. The bathing assistance apparatus of claim 10 wherein the back rest portion includes three inflatable tubular sections positioned one atop the other.

12. The bathing assistance apparatus of claim 1 and further comprising:
at least one suction cup secured to the seat portion of the seat assembly, the suction cup interactable with a surface of the bath tub.

13. The bathing assistance apparatus of claim 1 and further comprising:
an elongated tubing pneumatically connected between the seat assembly and the air pump.

14. The bathing assistance apparatus of claim 1 and further comprising:
an elevated tray table, the air pump positionable upon the elevated tray table;
a storage shelf formed in the elevated tray; and
a drainage port formed in the tray table.

15. The bathing assistance apparatus of claim 1 and further comprising:
a waterproof remote control for controlling the introduction and removal of air from the seat assembly.

16. A method for assisting a user getting into and out of a bath tub, the method comprising:
providing a seat assembly having an inflatable seat portion and a back rest portion;
extending the back rest portion in a generally upward direction from the seat portion;
pneumatically connecting an air pump to the seat portion of the seat assembly;
inflating the seat assembly thereby raising the seat portion of the seat assembly; and
deflating the seat assembly thereby lowering the seat portion of the seat assembly.

17. A bathing assistance apparatus for assisting a user getting into and out of a bath tub, the bathing assistance apparatus comprising:
a seat assembly having an inflatable seat portion and a back rest portion, the back rest portion extending in a generally upward direction from the seat portion, the seat portion having a plurality of inflatable chambers positioned one atop the other;
an air pump pneumatically connected to the seat portion of the seat assembly by an elongated tubing; and
at least one suction cup secured to the seat portion of the seat assembly, the suction cup interactable with a surface of the bath tub;
wherein the seat portion of the seat assembly is selectively inflatable and deflatable to raise and lower a user within the bath tub.

18. The bathing assistance apparatus of claim 16 wherein all chambers are selected from inflatable simultaneously and inflatable individually.

19. The bathing assistance apparatus of claim 16 wherein the back rest portion includes three tubular sections filled with a foam material.

20. The bathing assistance apparatus of claim 16 wherein back rest is inflatable and pneumatically connected to the seat portion of the seat assembly.
